(19) United States
(12) Patent Application Publication
(10) Pub. No.: US 2003/0052296 A1
(43) Pub. Date: Mar. 20, 2003

(54) Air flow control valve operating apparatus for internal combustion engine

(75) Inventor: Teruhiko Minegishi, Hitachinaka (JP)

Correspondence Address: Crowell & Moring LLp, The Evenson, McKeown, Edwards & Lenahan, Intellectual Property Law Gr., 1001 Pennsylvania Avenue, N.W., Washington, DC, 20004-2595, US

(73) Assignee: Hitachi, Ltd.

(21) Appl. No.: 10/084,066

(22) Filed: Feb. 28, 2002

(30) Foreign Application Priority Data
Sep. 20, 2001 (JP) 2001-286770

(51) Int. Cl. F16K 1/22

(52) U.S. Cl. 251/305

(57) ABSTRACT

A control valve driving mechanism for an internal combustion engine has a construction in which an electric motor is mounted inside a control valve. With this construction, the electric motor is prevented from projecting outward of an intake pipe, and the electric motor for driving the control valve serves also as a bearing for the control valve, and the electric motor for driving the control valve can be mounted in a compact manner, and the number of component parts can be reduced. This control valve driving mechanism thus enables the improvement of space factor and the use of a commercially-available, inexpensive electric motor to reduce the cost.

### BACKGROUND OF THE INVENTION

This invention relates to an operating apparatus for a valve controlling intake air flow to an internal combustion engine, such as a swirl valve and an intake length variable valve, and more particularly to an electric operating apparatus driven by an electric motor through a speed reduction mechanism.

A conventional control valve mechanism, for instance, has a stem extending through an independent intake branch of an internal combustion engine, and is adapted to drive a control valve through gears or the like, mounted on an end of the stem, by an electric motor provided at a position offset with respect to the stem axis. In this construction, the drive motor is disposed in a projected manner at the outside of an intake pipe, and therefore this is disadvantageous from the viewpoint of a compact design. And besides, the electric motor for driving the control valve has tended to use, not a speed reduction mechanism having a large reduction ratio and a compact design, an exclusive mechanism of a large size.

### BRIEF SUMMARY OF THE INVENTION

It is an object of the invention to provide a control valve driving mechanism for an internal combustion engine, which can improve the space factor and besides can reduce the cost by utilizing a commercially-available, inexpensive electric motor.

A control valve driving mechanism for an internal combustion engine according to the invention has a construction in which an electric motor is mounted within a control valve body. This construction is intended to enable the electric motor to be prevented from projecting outwardly from an intake pipe, and besides the electric motor for driving the control valve to serve also as a bearing for the control valve so that the electric motor for driving the control valve can be mounted in a compact manner and the number of the component parts can be reduced.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is an overall construction view showing a preferred embodiment of a control valve driving mechanism for an internal combustion engine according to the invention;

FIG. 2 is a section view taken along the line A-A in the overall construction view of the embodiment shown in FIG. 1;

FIG. 3 is an exploded, perspective view of the embodiment shown in FIG. 1;

FIG. 4 is a detailed view showing the construction of switches shown in FIG. 2;

FIGS. 5A to 5C are views explanatory of the operation of the switches shown in FIG. 4;

FIG. 6 is a view showing the construction of a signal wire and a connection portion shown in FIG. 2;

FIG. 7 is a view showing a construction taken when a resistance sensor is used as means for detecting the position of a control valve shown in FIG. 2;

FIG. 8 is a view showing a construction taken when a roller bearing is used in a bearing portion for a control valve stem shown in FIG. 2;

FIG. 9 is a section view of another embodiment of a control valve driving mechanism for an internal combustion engine according to the invention;

FIG. 10 is an exploded, perspective view of the embodiment shown in FIG. 9;

FIG. 11 is a section view of a further embodiment of a control valve driving mechanism for an internal combustion engine according to the invention;

FIG. 12 is an exploded, perspective view of the embodiment shown in FIG. 11;

FIG. 13 is an exploded, perspective view of the embodiment of FIG. 11 as seen from an electric motor side;

FIG. 14 a section view of a still further embodiment of a control valve driving mechanism for an internal combustion engine according to the invention;

FIG. 15 is a section view of a further embodiment of a control valve driving mechanism for an internal combustion engine according to the invention;

FIG. 16 is a characteristics diagram showing the performance of an DC electric motor;

FIG. 17 is a diagram showing an example of comparison in rotating speed between the electric motor according to the invention and commercially-available electric motors; and

FIG. 18 is a diagram showing an example of comparison in torque between the electric motor according to the invention and the commercially-available electric motors.

### DETAILED DESCRIPTION OF THE INVENTION

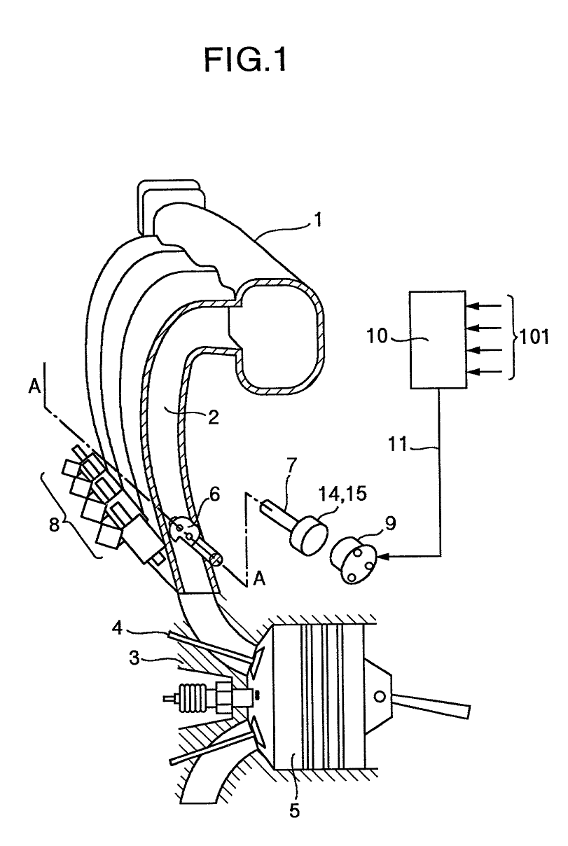

FIG. 1 shows an embodiment in which the present invention is applied to a swirl valve control mechanism for an internal combustion engine.

In FIG. 1, air to be drawn into an engine is fed from an intake pipe 1, and is drawn into a combustion chamber 5 of the engine 3 through an intake branch 2 and an intake valve 4, and at the same time fuel is injected in an amount, corresponding to the intake air amount, from a fuel injection device 8. For the purpose of improving the combustion of the air-fuel mixture in the combustion chamber 5, a swirl valve 6 is provided in the intake branch 2 so as to deflect a flow of the intake air in the intake branch 2, thereby producing a swirl in the combustion chamber 5. Such a system is commonly known both in the illustrated system for injecting fuel into the intake branch 2 and in a system for injecting fuel directly into the combustion chamber 5, and the present invention can be applied to either system.

The swirl valve 6 is fixedly secured to a valve stem 7, and planetary gear mechanisms 14 and 15 are provided at an end of the valve stem 7 and connected to an electric motor 9. Based on signals 101 from various sensors for the engine speed and so on, an engine control computer 10 computes an operating condition of the engine, and if it is judged from this computation result that it is necessary to operate the swirl valve 6, a signal or electric power is fed to the electric motor 9 via an electric wire 11, thereby operating the swirl valve 6.

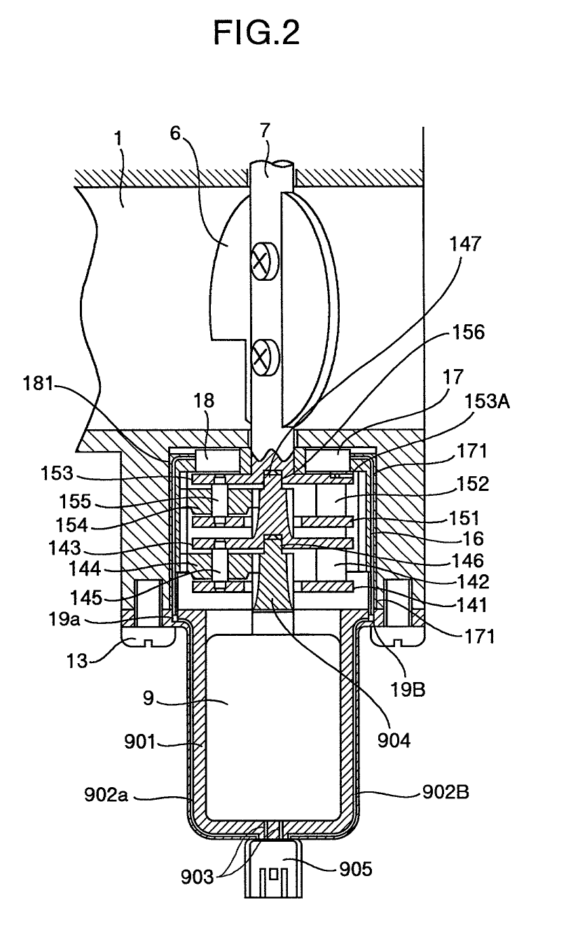

FIG. 2 is a section view taken along the line A-A of FIG. 1, and shows the connection of the swirl valve 6 to the electric motor 9 through the planetary gear mechanisms 14 and 15 in detail.

In FIG. 2, the electric motor 9 is fixedly mounted inside a casing 901, and the method of fixing the electric motor 9 to the casing 901 may be press-fitting or any other method such as adhesive-bonding. This casing 901 is fixedly secured to the body of the intake pipe 1 by fixing means 13.

An output of the electric motor 9 is transmitted to the planetary gear mechanism (speed change gear mechanism) 14 through a motor gear 904. The rotary motion of this motor gear 904 is transmitted to planetary gears 144 supported by a carrier A 141, a carrier B 143 and supports 142. A shaft 145 is provided at the center of rotation of each planetary gear 144, and the planetary gear 144 is adapted to be in mesh with the motor gear 904, rotate about its axis and revolve around the motor gear 904.

On the other hand, an internal gear 16 is fixedly mounted outside the planetary gears 144 on the body of the intake pipe 1 so as to be in mesh with the planetary gears 144. The carrier A 141, the supports 142, the carrier B 143, the planetary gears 144 and the shafts 145 jointly form the planetary gear mechanism 14.

In this construction, when the motor gear 904 rotates, the planetary gears 144 rotate and revolve on the carrier A 141 and the carrier B 143 according to the commonly-known operating principle of a planetary gear mechanism, and therefore the carrier A 141 and the carrier B 143 rotate at a predetermined reduction rate in the same direction as the direction of rotation of the motor gear 904. A distal end portion of the motor gear 904 is inserted in a rotation fitting portion 146 of the carrier B 143 with a clearance of the same level as obtained in a common bearing formed therebetween, and therefore the coaxial rotation of the motor gear 904 and speed change mechanism 14 can be secured. And besides, the distal end of the motor gear 904 abuts against the bottom of the rotation fitting portion 146 of the carrier B 143, and therefore there is achieved the effect of keeping an axial gap between adjacent planetary gears constant.

An output gear 147 is formed integrally on the carrier B 143. A rotary motion of the output gear 147, which rotates together with the carrier B 143, is transmitted to planetary gears 154 supported by a carrier A 151, a carrier B 153 and supports 152. A shaft 155 is provided at the center of rotation of each planetary gear 154, and the planetary gear 154 is adapted to be in mesh with the output gear 147, rotate about its axis and revolve around the output gear 147.

The internal gear 16 is fixedly mounted outside the planetary gears 154 on the body of the intake pipe 1 so as to be in mesh with the planetary gears 154. The carrier A 151, the supports 152, the carrier B 153, the planetary gears 154 and the shafts 155 jointly form the planetary gear mechanism 15.

In this construction, when the output gear 147 rotates, the planetary gears 154 rotate and revolve on the carrier A 151 and the carrier B 153 according to the commonly-known operating principle of a planetary gear mechanism, and therefore the carrier A 151 and the carrier B 153 rotate at a predetermined reduction rate in the same direction as the direction of rotation of the output gear 147. A distal end portion of the output shaft 147 is inserted in a rotation fitting portion 156 of the carrier B 153 with a clearance of the same level as obtained in a common bearing formed therebetween, and therefore the coaxial rotation of the output gear 147 and speed change mechanism 15 can be secured. And besides, the distal end of the output gear 147 abuts against the bottom of the rotation fitting portion 156 of the carrier B 153, and therefore there is achieved the effect of keeping an axial gap between adjacent planetary gears constant.

Thus, the output gear 147 is in mesh with the planetary gears 154 of the planetary gear mechanism 15. The gear-meshing construction of the constituent elements, that is, the carrier A 151, the supports 152, the carrier B 153, the planetary gears 154, the shafts 155 and the rotation fitting portion 156, of the planetary gear mechanism 15 is the same as that of the planetary gear mechanism 14, and therefore the two planetary gear mechanisms 14 and 15 do the same operation. The internal gear 16 is common to the planetary gear mechanism 14 and the planetary gear mechanism 15. The valve stem 7 is integrally fixed to the carrier B 153, and the swirl valve 6 is fixedly secured to this valve stem 7. The term “integrally-fixing” used herein means the fixing obtained by fixing methods such as integral formation, welding, press-clamping and screw-fastening.

A switch A 17 and a switch B 18 are provided on that portion of the internal gear 16 opposed to a stepped portion 153a of the carrier 153. A signal wire 171 from the switch A 17 and a signal wire 181 from the switch B 18 are provided integrally in the inside of the internal gear 16. These signal wires 171 and 181 are connected at connection portions 19a and 19b respectively to signal wires 902a and 902b which are provided integrally in the inside of the casing 901. The signal wires 902a and 902b in the inside of the casing 901 are connected, together with a power wire 903 from the electric motor 9, to a connector portion 905 formed integrally on the casing 901.

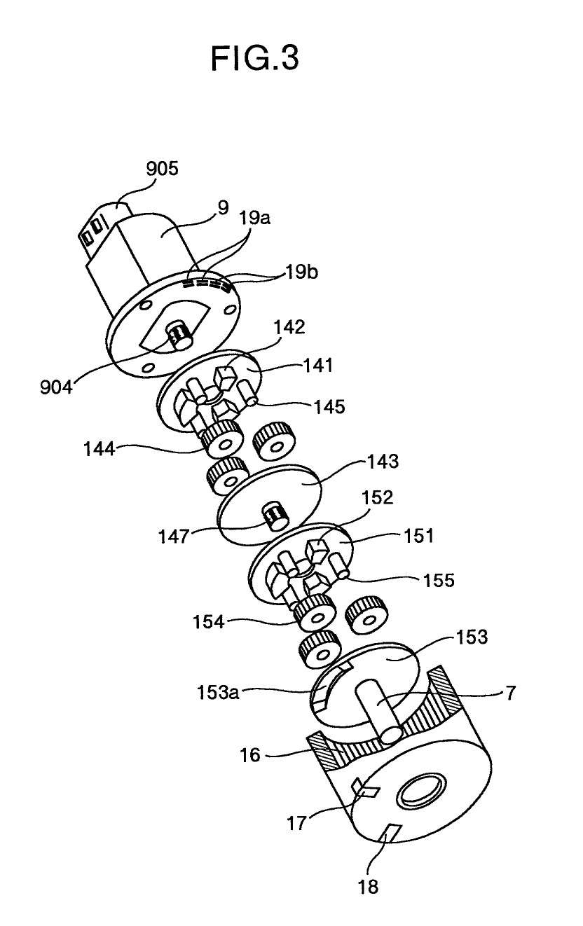

FIG. 3 is an exploded, perspective view of the swirl valve 6, the planetary gear mechanisms 14 and 15 and the electric motor 9 shown in FIG. 2. In this figure, the same reference numerals as those of FIG. 2 denote identical members.

In FIG. 3, the supports 142 and the shafts 145 are formed integrally on the carrier A 141, and the supports 152 and the shafts 155 are formed integrally on the carrier B 143, and it is clear that even with this construction, the satisfactory operation of the planetary gear mechanisms can be achieved.

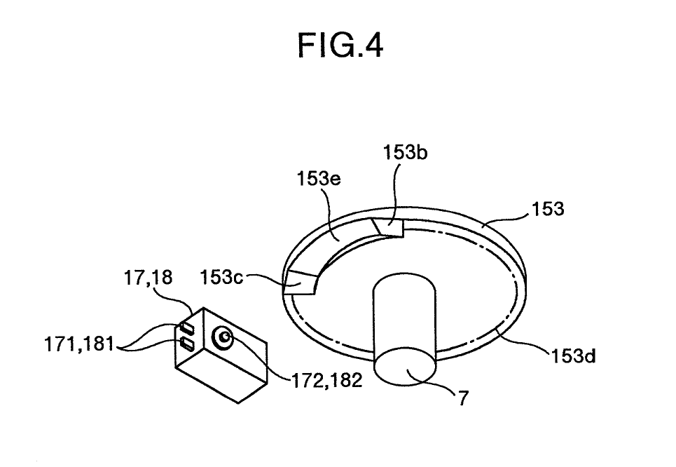

FIG. 4 shows details of the carrier B 153, switch A 17 and switch B 18.

More specifically, in FIG. 4, detection portions 172 and 182 are provided on the switch A 17 and switch B 18, respectively. Either by depressing the detection portion 172, 182 of the switch A 17, B 18 or by canceling a depressed condition of the detection portion 172, 182 of the switch A 17, B 18, electrical connection within the switch A 17, B 18 can be made or broken. The completion or breaking of the electrical connection within the switch appears as a signal on the signal wire 171, 181.

Next, the positional relation in engagement between the carrier B 153 and the switches A 17 and B 18 will be described.

The detection portions 172 and 182 of the switch A 17 and switch B 18 are so located as to trace a dotted-line portion 153d on a flat portion of the lower surface of the carrier B 153. Also, in the direction of the axis of the valve stem 7, the detection portions 172 and 182 of the switch A 17 and switch B 18 are so positioned relative to the carrier B 153 that when the detection portions 172 and 182 are on the dotted-line portion 153d of the carrier B 153, they are depressed. When the valve stem 7 rotates, the carrier B 153 rotates therewith, and the detection portions 172 and 182 of the switch A 17 and switch B 18 slide on the dotted-line portion 153d of the flat portion of the carrier B 153. During the time when the detection portions 172 and 182 of the switch A 17 and switch B 18 are in sliding contact with the dotted-line portion 153d of the flat portion of the lower surface of the carrier B 153, the detection portions 172, 182 are kept depressed by the lower surface of the carrier B 153.

The detection portions 172 and 182 of the switch A 17 and switch B 18 thus slide on the dotted-line portion 153d of the flat portion of the carrier B 153, and when the detection portion 172, 182 reaches the stepped portion 153a of the carrier B 153, this stepped portion 153a allows the depressed or retracted detection portion 172, 182 to be extended, thus releasing this detection portion. Ramp portions 153b and 153c are provided to respectively extend from the dotted-line portion 153d of the flat portion of the carrier B 153 to the stepped portion 153a and from the stepped portion 153a to the dotted-line portion 153d. The ramp portions 153b and 153c are thus provided between the stepped portion 153a of the carrier B 153 and the flat portion of the carrier B 153 in order that the detection portions 172 and 182 of the switch A 17 and switch B 18, being in sliding contact with the lower surface of the carrier B 153, can smoothly trace the regions between the dotted-line portion 153d of the flat portion of the carrier B 153 and the stepped portion 153a.

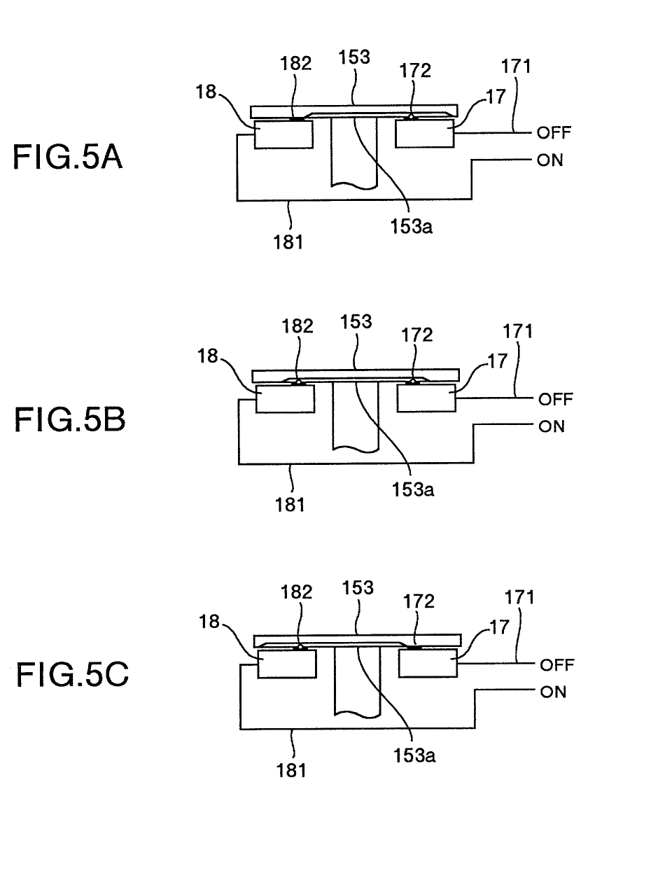

Next, the operation of the switches A 17 and B 18 will be described. In the drawings, FIG. 5A shows a state in which the valve stem 7 is in an initial position, FIG. 5B shows a state in which the valve stem 7 is in an intermediate position, and FIG. 5C shows a state in which the valve stem 7 is in a final position.

First, in the state wherein the valve stem 7 is in the initial position as shown in FIG. 5A, or in the condition of the carrier B 153 and the switches A 17 and B 18 when the swirl valve 6 is, for example, in its fully-closed position, the detection portion 172 of the switch A 17 is situated at the stepped portion 153a of the carrier B 153 and kept in the released condition, so that an OFF signal appears on the signal wire 171. On the other hand, the detection portion 182 of the switch B 18 is situated on the dotted-line portion 153b of the flat portion of the carrier B 153 and kept depressed, so that an ON signal appears on the signal wire 181.

When the valve stem 7 is rotated into the intermediate position as shown in FIG. 5B, or in the condition of the carrier B 153 and the switches A 17 and B 18 when the degree of opening of the swirl valve 6 is, for example, medium, the detection portion 172 of the switch A 17 is situated at the stepped portion 153a of the carrier B 153 and kept in the released condition, so that the OFF signal appears on the signal wire 171. On the other hand, the detection portion 182 of the switch B 18 is also situated at the stepped portion 153a of the carrier B 153 and kept in the released condition, so that the OFF signal appears on the signal wire 181.

When the valve stem 7 is further rotated into the final position as shown in FIG. 5C, or in the condition of the carrier B 153 and the switches A 17 and B 18 when the swirl valve 6 is, for example, in its fully-open condition, the detection portion 172 of the switch A 17 is situated on the dotted-line portion 153d of the flat portion of the carrier B 153 and kept in the depressed condition, so that the OFF signal appears on the signal wire 171. On the other hand, the detection portion 182 of the switch B 18 is situated at the stepped portion 153a of the carrier B 153 and kept in the released condition, so that the OFF signal appears on the signal wire 181.

Thus, the open and closed conditions of the swirl valve 6 can be detected by monitoring the signals of the switches A17 and B 18. The output condition of the switches A17 and B18 may be inverted such that the outputs of the switches A 17 and B 18 are the OFF signals when the detection portions 172 and 182 of these switches are depressed, in which case, also, the open and closed conditions of the swirl valve 6 can be detected.

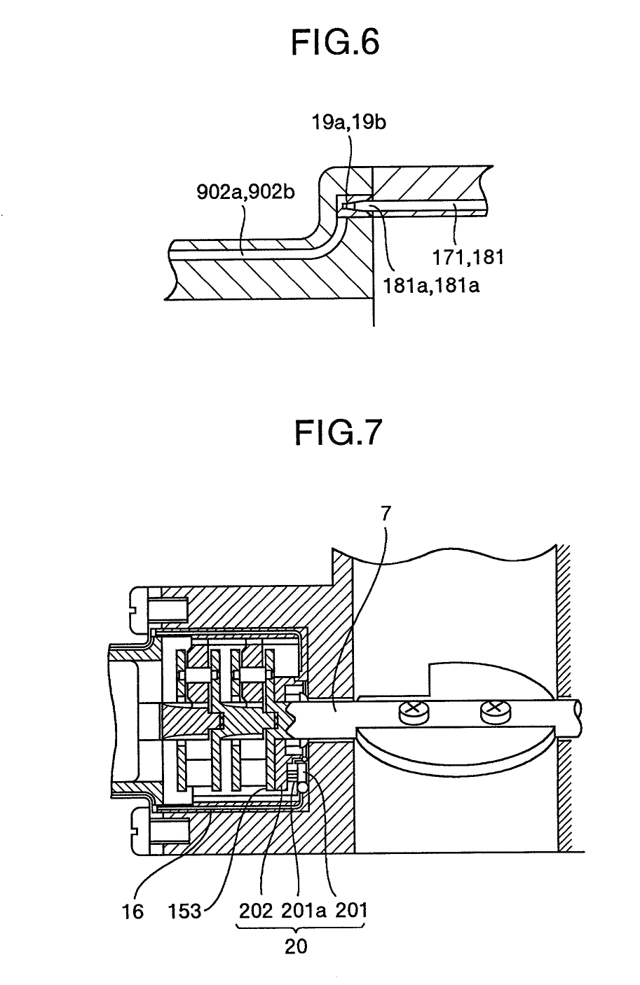

FIG. 6 shows the connection portion between the signal wire from the switch and the signal wire in the inside of the casing of the electric motor.

In FIG. 6, the signal wire 902a, 902b is fixedly secured to the connection portion 19a, 19b, and this connection portion 19a, 19b is made of an electrically-conductive material having a spring action. A protruding portion 171a, 181a is formed at the distal end of the signal wire 171, 181, and is generally tapering toward its distal end, and when this protruding portion 171a, 181a is inserted into the connection portion 19a, 19b, the signal wire 171, 181 is electrically connected to the signal wire 902a, 902b. Here, the insertion of the protruding portion 171a, 181a into the connection portion 19a, 19b, as being set to be done in a direction parallel to the direction of fixing of the casing 901 to the body 1 by the fixing means 13, is effected simultaneously when effecting this fixing operation, and any special connecting operation is not required. Although, in this embodiment, the connection portion 19a, 19b is formed to be fixedly secured on the side of the signal wire 902a, 902b, it will be apparent that another construction, in which the connection portion 19a, 19b is secured to the end of the signal wire 171, 181 while the protruding portion is formed on the signal wire 902a, 902b side, may be used to have a similar effect.

FIG. 7 shows an example in which a resistance-type sensor is used as a measure for detecting the position of the swirl valve. In this figure, the same reference numerals as those of FIG. 2 denote identical members.

In FIG. 7, a valve stem 7 is fixed integrally to a carrier B 153 as in the first embodiment. A rotor 202, coated with a resistance track, is provided on this carrier B 153, and this rotor 202 rotates together with the carrier B 153. A sensor housing 201 is fixedly secured to an internal gear 16. A contact 201a is provided on this sensor housing 201, and this contact 201a is held in contact with the rotor 202 so as to output a signal representative of a change of the resistance. The sensor housing 201, the contact 201a and the rotor 202 jointly form a resistance-type sensor 20. It will be readily appreciated that another construction, in which the rotor 202 is fixedly secured to the internal gear 16 while the sensor housing 201 is fixedly secured to the carrier B 153, may be used to achieve a similar function.

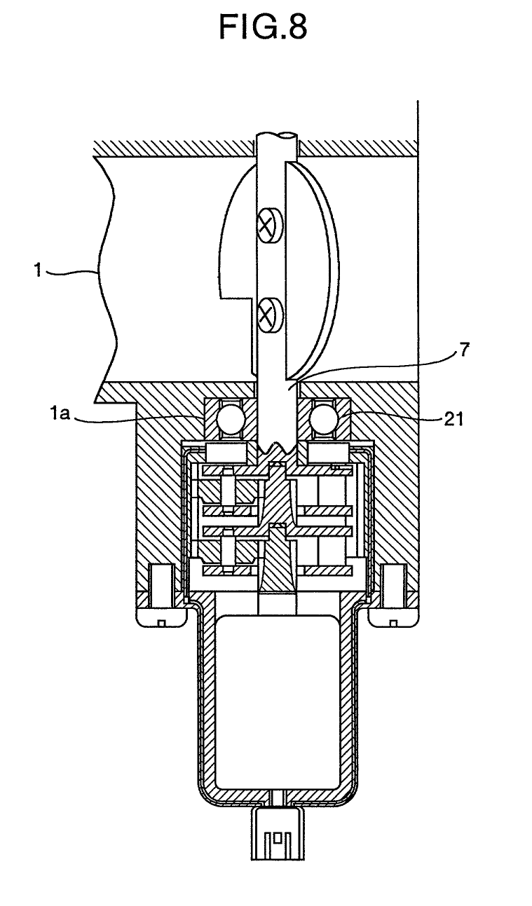

FIG. 8 shows an example in which a roller bearing is used at a bearing portion of a swirl valve stem. In this Figure, the same reference numerals as those of FIG. 2 denote identical members.

In FIG. 8, a bearing housing 1a is formed on the body of an intake pipe 1, and the roller bearing 21 is fitted in and fixed to this bearing housing 1a. The valve stem 7 extends through an inner race of the roller bearing 21, and this roller bearing 21 supports the valve stem 7. In this embodiment, as the roller bearing is used to support the valve stem, the reduction of a rotational resistance of the bearing system, the improvement of the rotation precision and the improvement of the reliability can be achieved.

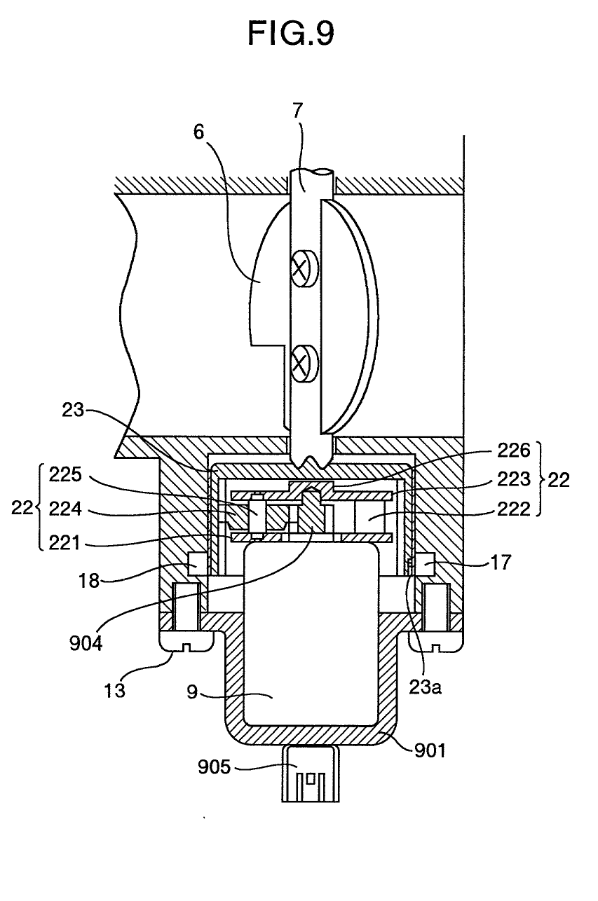

FIG. 9 shows a construction in which the planetary gear mechanisms, described above in FIG. 2, are replaced by a single-stage planetary gear mechanism. In this Figure, the same reference numerals as those of FIG. 2 denote identical members.

In FIG. 9, an electric motor 9 is fixedly mounted inside a casing 901 in the same manner as described above in FIG. 2. In this embodiment, a carrier C 221 is fixedly secured to the electric motor 9.

An output of the electric motor 9 is transmitted to a planetary gear mechanism 22 via a motor gear 904. The motor gear 904 is in mesh with planetary gears A 224, supported by the carrier C 221, a carrier D 223 and supports 222, to transmit its rotary motion to these planetary gears A 224. A shaft 225 is provided at the center of rotation of each planetary gear A 224, and the planetary gear A 244 is in mesh with the motor gear 904 and rotates about its axis. An internal gear 23 is provided outside the planetary gears A 244 to be in mesh therewith. In this construction, when the motor gear 904 rotates, the internal gear 23 is rotated through the planetary gears A 224 since the carrier C 221 is not rotated.

A valve stem 7 is fixed integrally to the internal gear 23, and upon rotation of the electric motor 9, the valve stem 7 is rotated. Similarly to the embodiment described with reference to FIG. 2, a distal end portion of the motor gear 904 is formed for insertion into a rotation fitting portion 226 of the carrier D 223, and therefore the coaxial rotation of the motor gear 904 and planetary gear mechanism 22 can be secured.

A switch A 17 and a switch B 18 are provided on the body of an intake pipe 1. These switches A 17 and B 18 are identical in construction to those described above in FIG. 2, and have detection portions, not shown, respectively, and completion or breaking of the electrical connection by depressing or releasing the detection portions is also made in the same manner. The detection portions and the internal gear 23 are arranged in such a gap relation that when the front side of the switch A 17, B 18 is situated on the outer peripheral surface of the internal gear 23, each detection portion is depressed, and when the switch A 17, B 18 is situated in a stepped portion formed in the outer peripheral surface of the internal gear 23, the depressed detection portion is released. Thus, as the internal gear 23 rotates, the detection portions of the switches trace the outer peripheral surface and stepped portion of the internal gear 23 in accordance with the rotation of the valve stem 7, and therefore when the stepped portion is properly positioned in the outer peripheral surface of the internal gear 23, the position of the valve stem 7 can be detected by ON-OFF signals in the same manner as the switch operation described above in FIG. 5.

Although not shown in the drawings, the configuration of the signal wires and the connection portions, shown in FIG. 2, is applicable to this embodiment, and signals of the switches A 17 and B 18 can be fed to a connector portion 905 as in the construction of FIG. 2.

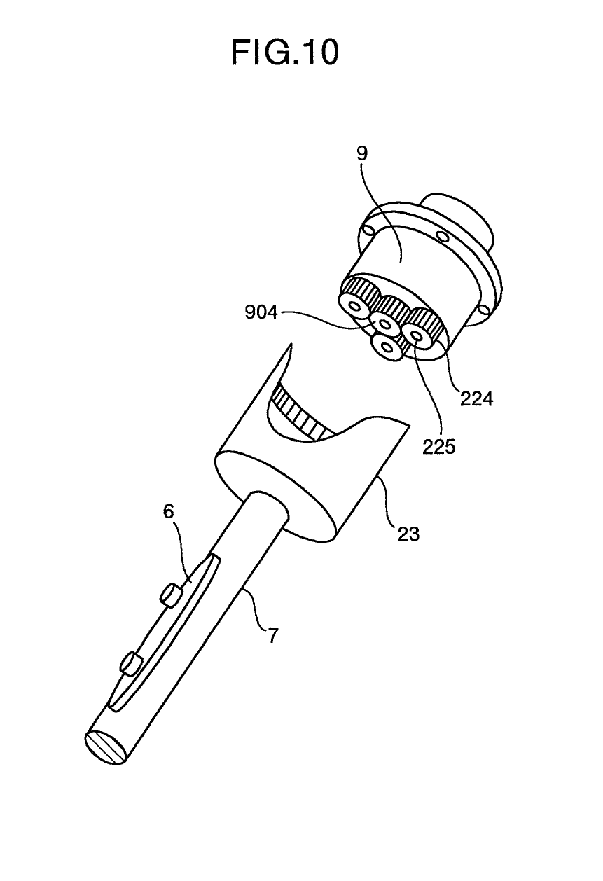

FIG. 10 shows an exploded, perspective view of the embodiment described in FIG. 9. In this Figure, the same reference numerals as those of FIG. 9 denote identical members.

In FIG. 10, in this embodiment, the carrier A 221, described in FIG. 9, is formed integrally with an electric motor 9. Although FIG. 10 shows the construction having no carrier B 223, the construction of this embodiment is sufficient in so far as the required rigidity or strength of connection between the electric motor 9 and the shafts 225 can be secured.

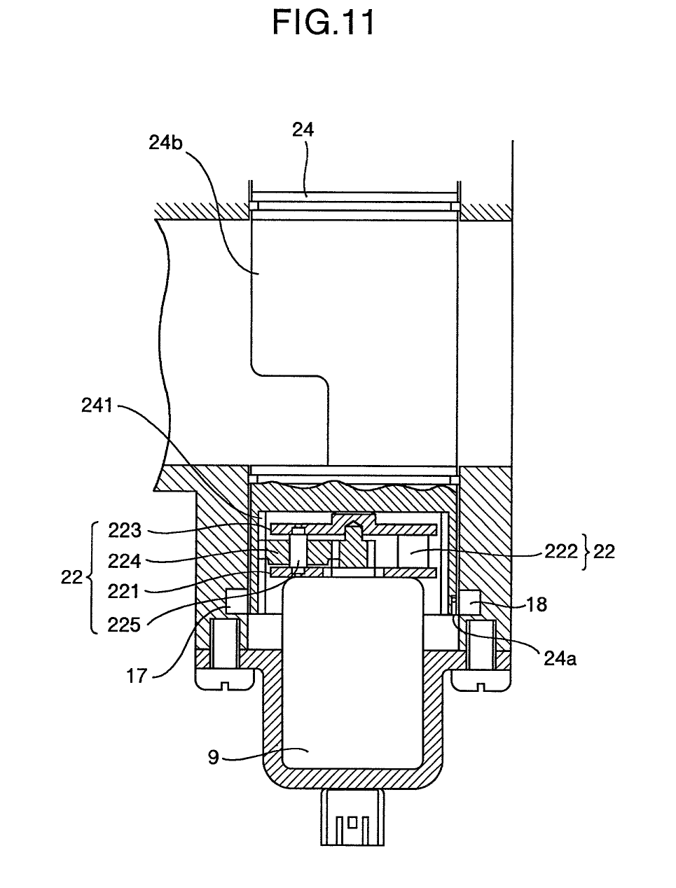

FIG. 11 is a section view showing a further embodiment, and in this figure, the same reference numerals as those of FIG. 2 denote identical members.

In the embodiment shown in FIG. 11, the construction concerning an electric motor 9, a planetary gear mechanism 22 and switches A 17 and B 18 is identical with that shown in FIG. 9, and the function is also the same. In this embodiment, a swirl valve 24 is of a one-piece construction, and a stepped portion 24a and an internal gear portion 241, associated with the switches A 17 and B 18, are formed integrally with a swirl valve portion 24b.

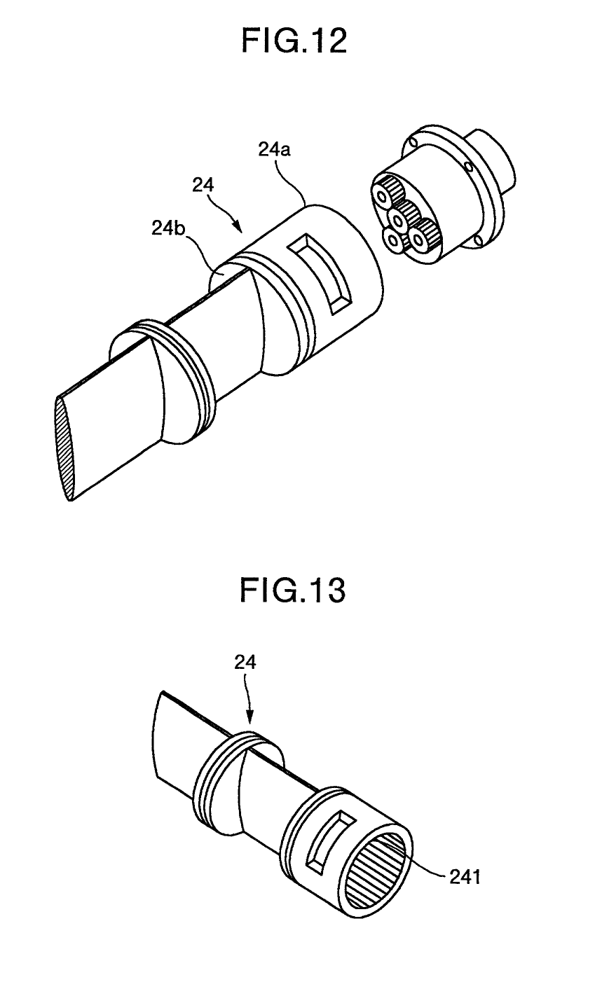

FIG. 12 shows an exploded, perspective view showing the embodiment of FIG. 11. In this figure, the same reference numerals as those of FIG. 11 denote identical members.

In FIG. 12, the swirl valve portion 24b of the swirl valve 24 has a plate-like shape as can be seen from its cross-section indicated by hatching in the figure. The swirl valve 24 is rotated so as to control the flow of air through a passage in the body of an intake pipe 1, not shown, and this operation of the swirl valve 24 is the same as that of the control valve proposed in JP-10-103110A.

FIG. 13 shows a state of the perspective view of FIG. 12 as seen from a different angle.

In FIG. 13, the swirl valve 24 is seen from the electric motor side, and the internal gear portion 241 is formed integrally within the swirl valve 24.

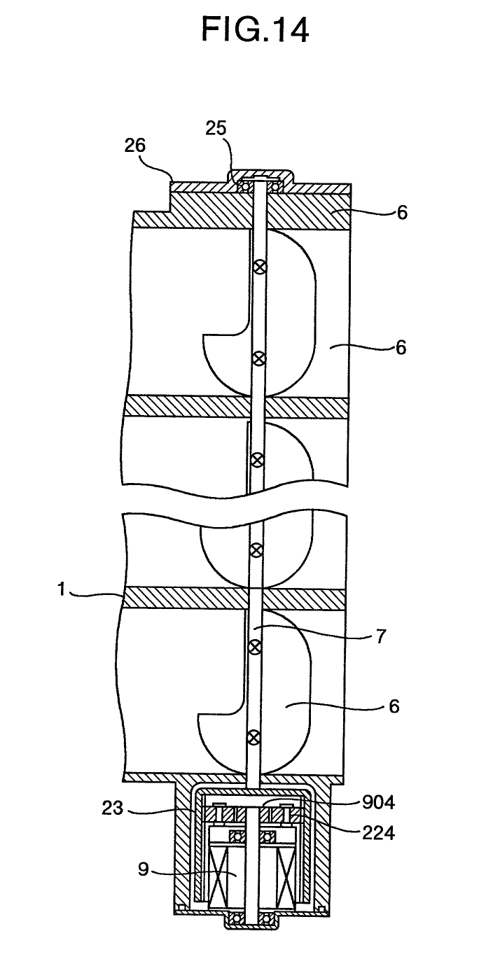

FIG. 14 is a section view showing the overall construction of another example of the embodiment shown in FIG. 9. In this figure, the same reference numerals as those of FIG. 9 denote identical members.

In FIG. 14, a valve stem 7 is of a multiple construction which extends through the body 1 of an intake pipe 1. Swirl valves 6 are fixedly secured to this valve stem 7, and therefore can rotate together with the valve stem 7. At that end of the valve stem 7 remote from an electric motor 9, a bearing 25 is fixedly secured to the body of the intake pipe 1 by a holder 26. Although the construction concerning switches A 17 and B 18 and signal wires is not described, it will be apparent that a similar construction to that of the embodiment of FIG. 9 is applicable.

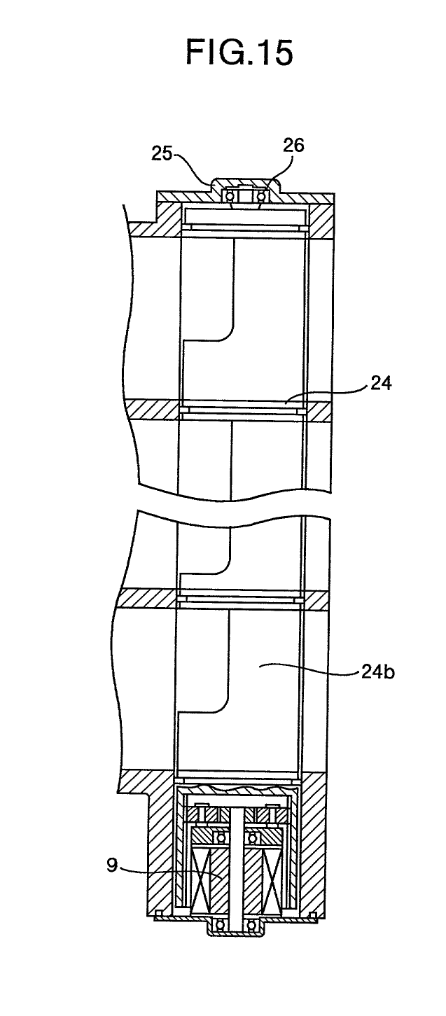

FIG. 15 is a section view showing the overall construction of another example of the embodiment shown in FIG. 11. In this figure, the same reference numerals as those of FIG. 11 denote identical members.

In FIG. 15, a swirl valve 24 is of a multiple construction which extends through the body of an intake pipe 1. The swirl valve 24 is of a one-piece construction having integral swirl valve portions 24b, which rotate together with the swirl valve 24. At that end of the swirl valve 24 remote from an electric motor 9, a bearing 26 is fixedly secured to the body of the intake pipe 1 by a holder 25. Although the construction concerning switches A 17 and B 18 and signal wires is not described, it will be apparent that a similar construction to that of the embodiment of FIG. 9 is applicable.

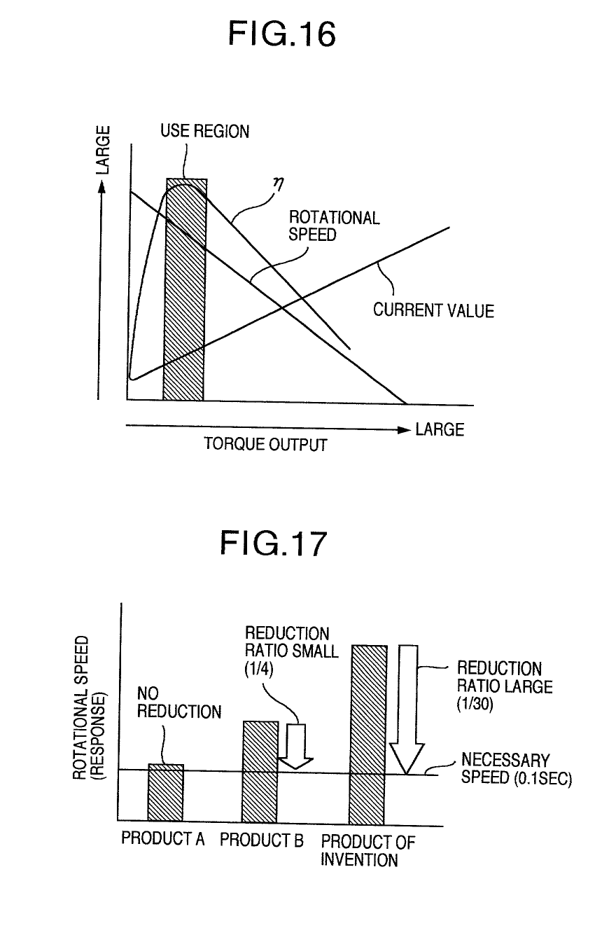

FIG. 16 shows an example of the performance diagram of an DC electric motor.

In a system for driving a swirl valve by an electric motor, it is common to use an exclusive electric motor of a high power which can produce a large torque output in a low-speed rotation region, and can freely select the rotational speed. When it is desired to achieve a compact, inexpensive and power-saving design of the system for driving the swirl valve by the electric motor, it is effective to use a compact electric motor for people's livelihood purposes.

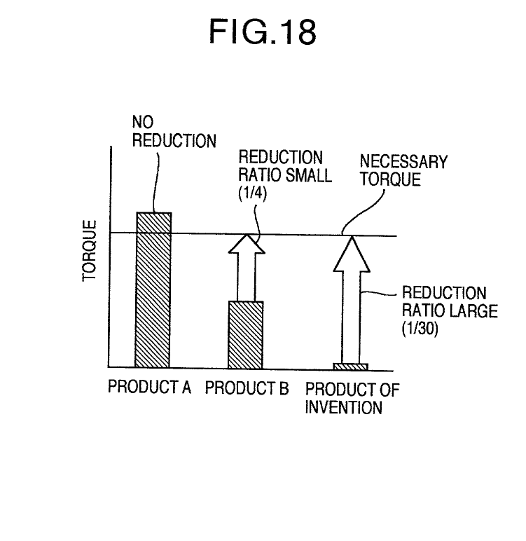

It is advantageous to use such an electric motor in a high-speed operating region where the efficiency η is high, as shown in FIG. 16. However, generally, with respect to the torque and operating speed required for the swirl valve, the inexpensive, compact electric motor for people's livelihood purposes is too high (about 3,000 to 6,000 rpm) in rotational speed, as shown in FIG. 17, as compared with a high-power electric motor A for exclusive use (in which for example, an expensive material, such as neodymium, is used in a magnet) and an exclusive high-power electric motor B (in which for example, a common material is used in a magnet, but the electric motor has a large outer diameter, and hence has the large size). In addition, because of its compact size, the torque output of this electric motor is small as shown in FIG. 18, and it can not be used in a convenient manner. Therefore, there is needed a speed change mechanism of a large reduction ratio for the purpose of reducing the rotational speed to a speed (response time of about 0.1 sec.) required for rotating the swirl valve stem 7 through an angle of 90 degrees, for the purpose of setting the reduction ratio to 20 to 40, and for the purpose of increasing the torque.

As is well known, a reduction ratio of about 1/10 can be easily obtained by the use of a planetary gear mechanism, and the reduction ratio can be easily multiplied by a multi-stage construction. As a speed reduction mechanism for obtaining a large reduction ratio, it may be proposed to use other gear mechanism, employing spur gears or worm gears, than the planetary gear mechanism. However, in a multi-stage spur gear mechanism, many gear support shafts need to be arranged generally in a plane, and this will not meet the requirement of the compact design. In a worm gear mechanism, it is possible to reduce the number of gear stages, but a rotational shaft of an electric motor is disposed perpendicularly to a swirl valve stem, and therefore it is difficult to provide this mechanism in the swirl valve stem as is in the present invention. And besides, a worm gear and a worm wheel, while slipping, transmit the rotation, and in view of this transmission characteristics, the transmission efficiency is lowered, and this is a problem in the case of using a compact electric motor of a small output.

The above embodiments of the invention are so constructed that the open and closed conditions of the swirl valve are detected by the associated switches or the potentiometer to be reflected in the control of the engine, and therefore, the emission of the engine can be improved, and the performance thereof can be enhanced.

Although the above embodiments have been directed to the swirl valve, the drive mechanism of these embodiments can be used as a drive mechanism for a variable intake length valve.

As described above, according to the invention, the speed change mechanism can be provided on the axis between the electric motor and the control valve, and therefore the compact construction can be achieved. And besides, the compact speed change mechanism of a large reduction ratio serves also as the bearing for supporting that end of the control valve stem close to the electric motor, and because of the provision of the speed reduction mechanism of a large reduction ratio, an inexpensive electric motor for people's livelihood purposes can be used, and therefore the cost can be reduced.

It will be further understood by those skilled in the art that the foregoing description has been made on embodiments of the invention and that various changes and modifications may be made in the invention without departing from the spirit of the invention and the scope of the appended claims.

What is claimed is:

1. A control valve driving mechanism for an internal combustion engine, comprising:
a control valve having a valve stem;
an electric motor as a drive source for driving the control valve, said electric motor having an output shaft, an axis of rotation of said output shaft of said electric motor being coaxial with an axis of rotation of said valve stem of said control valve; and
a speed change gear mechanism for changing a speed of rotation of said electric motor and for transmitting the rotation to said control valve, said mechanism being provided between said control valve stem and said output shaft of said electric motor.

2. A control valve driving mechanism according to claim 1, wherein said speed change gear mechanism is arranged around said control valve stem and said output shaft of said electric motor.

3. A control valve driving mechanism according to claim 1, wherein said speed change gear mechanism comprises at least one-stage planetary gear mechanism.

4. A control valve driving mechanism according to claim 2, wherein said speed change gear mechanism comprises at least one-stage planetary gear mechanism.

5. A control valve driving mechanism according to claim 1, wherein a gear change ratio of said speed change gear mechanism is 20 to 40.

6. A control valve driving mechanism for an internal combustion engine, having an electric motor as a drive source for driving a control valve, comprising:
a pair of on-off switches;
a rotary shaft;
a member for turning on and off said pair of switches in accordance with rotation of said rotary shaft; and
a signal producing device for detecting conditions of said switches to detect a rotational position of said rotary shaft.

7. A control valve driving mechanism for an internal combustion engine, comprising:
a control valve having a valve stem;
an electric motor as a drive source for driving said control valve, said motor having an output shaft;
a planetary gear mechanism provided between said valve stem of said control valve and said output shaft of said electric motor, said mechanism including an internal gear casing and a carrier disposed close to said control valve; and
a rotational position sensor provided between said internal gear casing and said carrier of said planetary gear mechanism.

8. A control valve driving mechanism according to claim 7, wherein said carrier of said planetary gear mechanism is formed integrally on an end portion of said control valve stem.

9. A control valve driving mechanism according to claim 7, wherein a gear change ratio of said planetary gear mechanism is 20 to 40.

10. A control valve driving mechanism for an internal combustion engine, comprising:
a control valve;
an electric motor as a drive source for driving said control valve;
a casing having an internal gear, said casing being formed at one end of said control valve, said electric motor being housed in said casing; and
a mounting flange for said electric motor, said flange being fixedly secured to an end portion of a body of a intake pipe.

11. A control valve driving mechanism according to claim 10, further comprising a rotational position sensor provided between said internal gear casing and a housing of the intake pipe body.

12. A control valve driving mechanism according to claim 10, wherein said casing with the internal gear, which is provided at the one end of said control valve, is formed integrally with said control valve into a one-piece product.
